(19) United States
(12) Patent Application Publication
(10) Pub. No.: US 2017/0081471 A1
(43) Pub. Date: Mar. 23, 2017

(54) POLYAMIDE CAPABLE OF BEING DEEPLY DYED AND METHOD FOR PREPARING THE SAME

(71) Applicant: LIANG HAW TECHNOLOGY CO., LTD., TAIPEI (TW)

(72) Inventors: FANG-JUEI CHOU, TAIPEI (TW); LI-CHUN YU, TAIPEI (TW); CHUN-YUNG YU, TAIPEI (TW); HAN-HSING HSIUNG, TAIPEI (TW)

(21) Appl. No.: 15/068,843

(22) Filed: Mar. 14, 2016

(30) Foreign Application Priority Data
Sep. 21, 2015 (TW) 104131190

(51) Int. Cl. C08G 69/16; C08G 69/14

(52) U.S. Cl. CPC C08G 69/16; C08G 69/14

(57) ABSTRACT

A polyamide capable of being deeply dyed and a method for preparing the same are revealed. The main material for polyamide is caprolactam. Amino groups are added to react during ring opening of caprolactam. Then polymerization is carried out to get polyamide in granular form or polyamide is made into fibers directly. The granules or fibers of polyamide prepared are not only capable of being deeply dyed, but also with lower dyeing temperature and better color fastness. Moreover, less time is required for dyeing and finishing processes due to simple manufacturing processes and fewer parameters involved. Thus the production cost is significantly reduced.

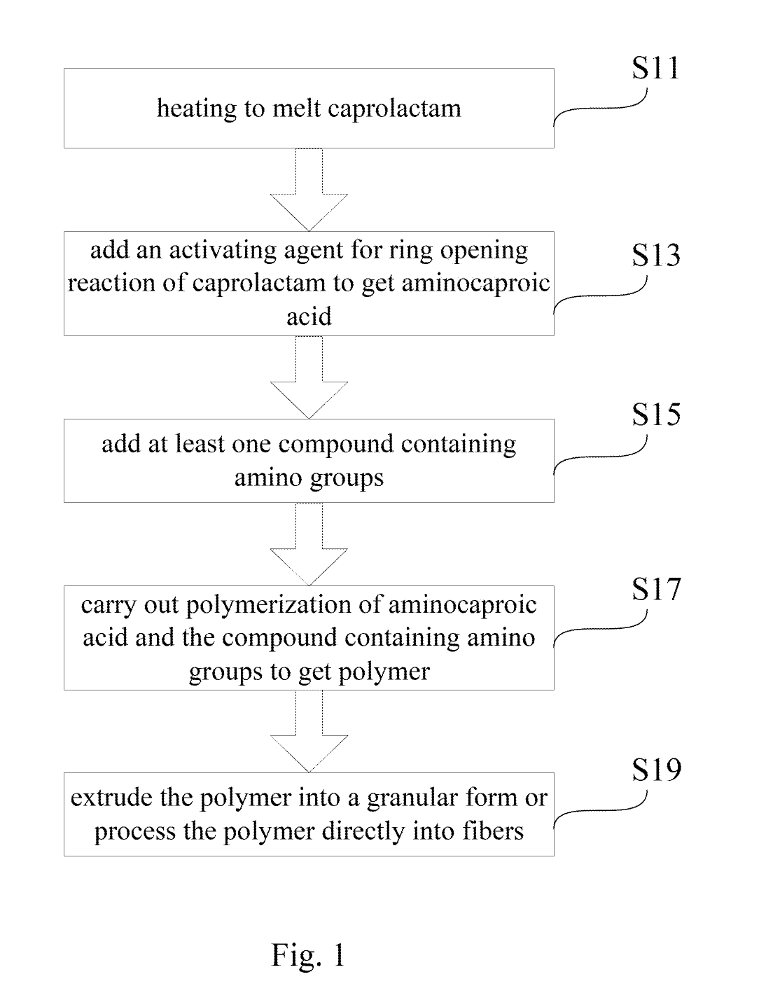

### BACKGROUND OF THE INVENTION

Field of the Invention

The present invention relates to a polyamide and a method for preparing the same, especially to a polyamide capable of being deeply dyed and a method for preparing the same.

Descriptions of Related Art

Polyamides (PA), also called nylon, are linear condensation polymers in which the repeating monomers are linked together by amide groups. The PA has been widely applied to textile industry and industrial fiber due to high tensile strength, high elasticity, high toughness, good abrasion resistance and moisture absorption, easy processing, and convenient preparation, especially on production of sportswear, shirts, sockets, raincoats, etc. Thus nylon fiber is close to our daily life. The nylon fiber can also be woven with other fibers to have more applications.

The main factors that affect dyeability of polyamide include dye-diffusion behavior, affinity between the fiber and the dye and bonding types. The molecular chain of polyamide includes large amount of carbon hydrogen bonds (—CH₂—) and amide groups (—CONH—) but only a few dyeable functional groups including carboxyl groups (—COOH—) and amino groups (—NH₂—) on two ends thereof.

According to the reason, only the acid dye contains hydrophilic groups of sodium sulfonate (—SO₃Na—) that bond to amino groups (—NH₂—) of polyamide fiber through ionic bonds or electrostatic force to make the polyamide fiber has more brilliant colors and better dyeability. As to other types of dyes including basic dyes, metal complex dyes, disperse dyes, azoic dyes, etc., they can only bond to polyamide fiber through hydrogen bonds or Van der Waals force. Thus these dyes have poor affinity to the polyamide. The color of the dyed polyamide is pale and uneven.

Although acid dyes have better affinity to polyamide fiber and the dyed polyamide has more brilliant color, the dyeing quality of polyamide is difficult to improve because that only a few carboxyl groups (—COOH—) and amino groups (—NH₂—) on two ends of the molecular chain of the polyamide are able to bond to acid dyes. In order to improve dyeability of the polyamide and color intensity of the dyed polyamide, looking for the ways to increase the amount of carboxyl groups or amino groups in polyamide molecules has become an important issue in the textile research.

Refer to Taiwanese Pat. App. No 201104038, the method available now used to improve dyeing properties of polyamide is adding compatibilizer precursors into a blend of polyamide and other polymers for modifying molecular structure of polyamide. Then compounds containing amino groups, carboxyl groups or epoxy groups are added into the melted blend of the modified polyamide polymer to increase the part of polyamide molecules capable of being dyed. Lastly the polyamide is dyed with acid dyes. However, the method has only a small production capacity because the modified polyamide with amino groups needs to be mixed with unmodified polyamide polymer for melt spinning processes. Thus the polyamide is unable to be mass-produced. In contrast, the modifying method has limits on improving concentration of amino groups in polyamide when polyamide fiber produced is finer (lower diameter). Thus fine polyamide fiber or multiple fibers are difficult to be dyed deeply. The dyeing properties such as residual absorption, washing fastness etc are not good. The dyeing quality is not stable enough for industrial applications.

Thus how to improve dyeability and poor dyeing quality of polyamide has become a challenge to overcome.

### SUMMARY OF THE INVENTION

Therefore it is a primary object of the present invention to provide a polyamide capable of being deeply dyed, having better color fastness, stable quality and suitable for mass production.

It is another object of the present invention to provide a method for preparing polyamide capable of being deeply dyed that features on simple manufacturing processes and fewer parameters involved. Thus time required for dyeing and finishing processes is shortened and production cost is significantly reduced.

In order to achieve the above objects, a method for preparing polyamide of the present invention includes a plurality of steps. Firstly provide melted caprolactam and add an activating agent for ring opening of caprolactam to get aminocaproic acid. Mix a compound containing amino groups with aminocaproic acid to get a mixture. After the mixture being heated for polymerization, extrude the mixture into particles or spin the mixture into fibers directly.

The caprolactam is heated to melt at a melting temperature ranging from 200° C. to 270° C.

The activating agent can be water or an alkaline substance.

The compound containing amino groups can be ethylenediamine, diethylenetriamine, triethylenetetramine, tetraethylenepentamine, pentaethylenehexamine, hexaethyleneheptamine, other polyethylenepolyamine, and their derivatives.

The polymerization temperature is ranging from 220t to 290° C.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

The FIGURE is a flow chart showing steps for preparing polyamide capable of being deeply dyed according to the present invention.

### DETAILED DESCRIPTION OF THE PREFERRED EMBODIMENT

In order to learn features and functions of the present invention, please refer to the following embodiment and related description in details.

In order to solve the problem of polyamide available now that is unable to be dyed deeply, the present invention provides a method for preparing polyamide particles containing amino groups and having high affinity to acid dyes. Moreover, the polyamide particles with good dyeing properties and stable quality can be mass-produced. The dyeing properties include residual absorption, washing fastness, etc. The method of the present invention makes a breakthrough.

In conventional preparation of polyamide, compatibilizer precursors are added into a blend of copolymer of polyamide and polyolefin for modifying molecular structure of the copolymer. Then compounds containing amino groups, carboxyl groups or epoxy groups are added into the melted blend. Next a certain ratio of unmodified polyamide polymer is added into the blend for following melt spinning, dyeing and finishing processes. Compared with the processes mentioned above, the present invention provides a method for preparing polyamide with easy steps and better quality. Caprolactam (CPL) is used as the main material for producing polyamide. Then amino groups are added directly for copolymerization during ring opening polymerization of caprolactam. Next the product extruded into particles capable of being dyed deeply.

The followings are detailed description of materials, features and parameters involved during preparation of polyamide of the present invention.

A composition of polyamide capable of being deeply dyed according to the present invention includes 80%-99.99 wt. % (weight percent) of caprolactam and a 0.01%-20% wt. % of the compound(s) containing amino groups.

A material for producing nylon fiber of the present invention is caprolactam. Caprolactam is a ring structured molecule. During industrial processes, an activating agent and a molecular weight stabilizer are added to initiate ring opening polymerization of caprolactam and get linear polymer, polycaprolactam, also known as polyamide 6. The plasticizing point and melting point of polyamide 6 are lower than other polyamide materials. The polyamide 6 fiber can be obtained by chip spinning and direct spinning.

The compounds containing amino groups can be polyamine compounds with at least two amino groups. Active amino groups of polyamines are bonded to caprolactam during ring opening polymerization of caprolactam. These amino groups are able to be bonded with acid dyes in the following dyeing process so that polyamide molecule can be deeply dyed. The suitable polyamines include ethylenediamine, diethylenetriamine, triethylenetetramine, tetraethylenepentamine, pentaethylenehexamine, hexaethyleneheptamine, other polyethylenepolyamine, and their derivatives.

Refer to the FIGURE, a method for preparing polyamide capable of being deeply dyed includes the following steps.
Step S11: heat to melt caprolactam.
Step S13: add an activating agent for ring opening reaction of caprolactam to get aminocaproic acid;
Step S15: add at least one compound containing amino groups;
Step S17: carry out polymerization of aminocaproic acid and the compound containing amino groups to get polymer;
Step S19: extrude the polymer into a granular form or process the polymer directly into fibers.

In the Step S11 of heating to melt caprolactam, caprolactam is set in a melting apparatus such as a melting pot and heated to melt at a melting temperature ranging from 200° C. to 270° C. Thus melted caprolactam is obtained.

Refer to the step S13, an activating agent is added into 80 wt. % to 99.99 wt. % of caprolactam for ring opening of caprolactam monomer to get aminocaproic acid monomer. The following FIGURE shows the ring opening reaction.

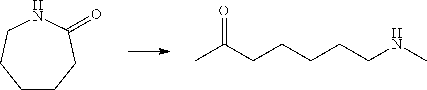

The activating agent can be water or an alkaline substance that is an alkali metal or an alkaline earth metal. During the ring opening of the caprolactam monomer, the weight percent of the activating agent mixed into caprolactam monomer is ranging from 1% to 3% and the reaction temperature is 210° C. to 250° C. Thus an aminocaproic acid monomer is obtained.

In the step S15, the ring-opened aminocaproic acid monomer is introduced into a continuous polymerization reactor and the 0.01%-20% wt. % of the compound containing amino groups is added. The compound containing amino groups provides active amino groups to bond to caprolactam during ring opening polymerization of caprolactam. The active amino groups can react with acid dyes in the following dyeing process so as to make the polyamide molecule become capable of being deeply dyed. The suitable compound containing amino groups is selected from the following compounds: ethylenediamine, diethylenetriamine, triethylenetetramine, tetraethylenepentamine, pentaethylenehexamine, hexaethyleneheptamine, and other polyethylenepolyamine, or their derivatives.

In the step S17, the aminocaproic acid monomer and the compound containing amino groups are polymerized and the temperature of the continuous polymerization reactor is controlled ranging from 220° C. to 290° C. Generally, the continuous polymerization reactor is formed by 3 to 5 vertical tubes for convenience of water drainage and getting a certain heating surface. The reactor is disposed with baffles therein to deflect flows of materials in the reactor. The baffle is in different shapes such as flat, inclined, curved, conical, helical, etc. The time difference between the material close to the reactor wall stayed in the reactor and the material at the center of the reactor remained in the reactor is reduced. Thus the materials in the reactor flow homogeneously.

In the step S19, the polymer of aminocaproic acid is extruded into filaments by an extrusion machine (such as a twin screw extruder). Or the extruded substance is cut into beads after water-cooling to form nylon particles.

Refer to the following embodiments in order to learn details, features and implementation of the present invention.

Preparation of Polyamide Capable of Being Deeply Dyed

A 98 wt. % of caprolactam is set in a melting pot and is heated to 230° C. (the melting temperature). Then the caprolactam is introduced and set in a pre-polymerization reactor and the temperature is controlled at 270° C. Then 2% by weight of water used as the activating agent is added into the pre-polymerization reactor. After ring opening polymerization of caprolactam, aminocaproic acid obtained is introduced into a continuous polymerization reactor for polymerization. A compound containing amino groups is added into the continuous polymerization reactor to carry out copolymerization. Thus the amount of the amino groups contained in the polymer product (polyamide) is increased and the polyamide becomes capable of being dyed deeply. The temperature of continuous polymerization is 270° C. The polymer obtained is introduced into a twin screw extruder for being extruded into filaments. Or the extruded polymer is chopped into beads after water-cooling to form nylon particles. Thus the preparation of polyamide capable of being dyed deeply is completed.

Property Test Results of Products Made from Polyamide Capable of Being Deeply Dyed

Refer to test items in the Table one, color fastness test results of the polyamide prepared by the present invention have been shown.

TABLE 1
color fastness test results of polyamide capable of
deeply dyed (including color fading and bleeding of color)

| | | | degree of staining | | | | | |
|---|---|---|---|---|---|---|---|---|
| test item | | color | (staining of undyed material) | | | | | |
| (color | | change/ | Ac | C | N | T Tri- | A | W |
| fastness to) | | fading | Acrylic | Cotton | Nylon | acetate | Acetate | Wool |
| washing | | 4-5 | 4-5 | 4-5 | 4-5 | 4-5 | 4-5 | 4-5 |
| water | | 4-5 | 4-5 | 4-5 | 4-5 | 4-5 | 4-5 | 4-5 |
| perspiration | acid | 4-5 | 4-5 | 4-5 | 4-5 | 4-5 | 4-5 | 4-5 |
| | base | 4-5 | 4 | 4 | 4-5 | 4 | 4-5 | 4-5 |
| rubbing | dry | 4-5 | 4-5 | 4-5 | 4-5 | 4-5 | 4-5 | 4-5 |
| | wet | 4-5 | 4-5 | 4-5 | 4-5 | 4-5 | 4-5 | 4-5 |

The above test results of polyamide prepared by the method of the present invention show no obvious color change/color transfer (grade 4-5) in most of color fastness tests including color fastness to washing. color fastness to water, color fastness to perspiration, color fastness to rubbing, etc, except color fastness to alkaline perspiration (grade 4). The polyamide of the present invention has excellent color fastness properties compared with polyamide available now having fastness of almost grade 3-4 or grade 4 and especially poor fastness of the red dye. Moreover, color depth and intensity of the polyamide capable of being deeply dyed are better than those of the polyamide available now. The color depth of the present invention is more uniform. Moreover, less dye is used to get a heavier depth in the present invention, without the problems of uneven dyeing and bleeding as the conventional polyamide.

In summary, the polyamide of the present invention not only has lower dyeing temperature but also better color fastness after dyeing. The amino groups of polyamide fiber form covalent bonds with positively charged groups of the dye so that the color fastness is improved. Moreover, the manufacturing processes are simple and parameters involved are fewer. All the components are melted at once to get the polyamide. The time required for dyeing and finishing processes is shortened. Therefore the production cost is significantly reduced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for preparing polyamide capable of being deeply dyed comprising the steps of:
heating to melt caprolactam;
adding an activating agent for ring opening reaction of caprolactam to get aminocaproic acid;
adding at least one compound containing at least two amino groups;
carrying out polymerization of aminocaproic acid and the compound containing the amino groups to get polymer; and
extruding the polymer into a granular form with color fastness higher than grade 4.

2. The method as claimed in claim 1, wherein caprolactam is heated to melt at a melting temperature ranging from 200° C. to 270° C. in the step of heating to melt caprolactam.

3. The method as claimed in claim 1, wherein the activating agent is water or an alkaline substance.

4. The method as claimed in claim 1, wherein the compound containing the amino groups is selected from the group consisting of ethylenediamine, diethylenetriamine, triethylenetetramine, tetraethylenepentamine, pentaethylenehexamine, hexaethyleneheptamine, other polyethylenepolyamine, and their derivatives.

5. The method as claimed in claim 1, wherein a polymerization temperature is ranging from 220° C. to 290° C. in the step of carrying out polymerization.
